(19) United States
(12) Patent Application Publication
(10) Pub. No.: US 2015/0075790 A1
(43) Pub. Date: Mar. 19, 2015

(54) OILFIELD BIOCIDE

(71) Applicant: SCHLUMBERGER TECHNOLOGY CORPORATION, SUGARLAND, TX (US)

(72) Inventors: ANTHONY LOISEAU, RIO DE JANEIRO (BR); YIYAN CHEN, SUGAR LAND, TX (US); HEMANT K. J. LADVA, MISSOURI CITY, TX (US)

(73) Assignee: SCHLUMBERGER TECHNOLOGY CORPORATION, SUGARLAND, CA (US)

(21) Appl. No.: 14/028,276

(22) Filed: Sep. 16, 2013

(51) Int. Cl. C09K 8/58; E21B 43/16

(52) U.S. Cl. CPC C09K 8/58; E21B 43/16
USPC 166/279; 568/412; 507/213; 507/214; 507/221; 507/227; 507/268

(57) ABSTRACT

A well treatment fluid comprising a 2-oxo-aldehyde having 3 or more carbon atoms is disclosed herein. Methods to prepare and to utilize the fluid, and to inhibit biological degradation of a well treatment fluid, are also disclosed.

### RELATED APPLICATIONS

None.

### FIELD

The present disclosure relates to compositions and methods for treating subterranean formations. More particularly, it relates to compositions and methods for reducing the bacterial degradation of well treatment fluids.

### BACKGROUND

The statements in this section merely provide background information related to the present disclosure and may not constitute prior art.

Oilfield treatment operations may require fluids having a viscosity suitable to maintain particles in suspension, or be required to have other properties for similar applications. For instance, drilling fluids may be required to suspend cutting or weighting agent such as barite and hydraulic fracturing fluids may be required to suspend proppant particles. Biopolymers and various synthetic polymers are typically used as viscosifiers or gelling agents in such oilfield applications. However, such polymers may be subject to bacterial or other biological degradation, which may result in a decrease in viscosity or other rheological properties rendering the polymer unsuitable for a particular use.

Compositions and methods disclosed herewith offer an improved way to inhibit biological degradation and thus improve the physicochemical stability of treatment fluids susceptible to biological degradation.

### SUMMARY

According to some embodiments, a well treatment fluid comprises a 2-oxo-aldehyde having 3 or more carbon atoms.

According to some embodiments, a method comprises combining a biopolymer with a 2-oxo-aldehyde having 3 or more carbon atoms in a carrier fluid to form a well treatment fluid.

According to some embodiments, a method of inhibiting biological degradation of a well treatment fluid susceptible to biological degradation comprises adding a biocidally effective amount of a 2-oxo-aldehyde having 3 or more carbon atoms to the treatment fluid.

### BRIEF DESCRIPTION OF THE DRAWINGS

FIG. 1 is a graphical representation showing the viscosity of a comparative example as a function of shear rate at room temperature, after 0, 1 and 2 days aging at 25° C.

FIG. 2 is a graphical representation showing the viscosity of an example according to one or more embodiments of the instant disclosure as a function of shear rate at 25° C. after 0, 1, 2, 3, and 6 days aging at 25° C.

FIG. 3 is a graphical representation showing the viscosity of a comparative example and examples according to one or more embodiments of the instant disclosure as a function of shear rate at 25° C. after 3 days of aging at 25° C.

FIG. 4 is a graphical representation showing the breaking schedule viscosity of an example according to one or more embodiments of the instant disclosure as a function of time at 66° C. (150° F.) at a shear rate of 100 sec⁻¹.

FIG. 5 is a graphical representation showing the viscosity of concentrated fluids according to one or more embodiments of the instant disclosure as a function of shear rate at room temperature, after 0, 1, 2, 3, and 4 days aging.

### DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure.

The description and examples are presented solely for the purpose of illustrating the preferred embodiments and should not be construed as a limitation to the scope. While the compositions are described herein as comprising certain materials, it should be understood that the composition could optionally comprise two or more chemically different materials. In addition, the composition can also comprise some components other than the ones already cited. In the summary and this detailed description, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range.

The following definitions are provided in order to aid those skilled in the art in understanding the detailed description.

The term “treatment,” or “treating,” refers to any subterranean operation that uses a fluid in conjunction with a desired function and/or for a desired purpose. The term “treatment,” or “treating,” does not imply any particular action by the fluid. Likewise, for purposes herein, a treatment fluid is any fluid suitable for use in treatment of a subterranean fluid. In embodiments, a treatment fluid may comprise one or more solutes at least partially dissolved in, or slurried with a carrier fluid. In an embodiment, a treatment fluid comprises a “man-made” mixture, and does not consist or consist essentially of a naturally occurring fluid as it exists without man-made intervention. While a component of a treatment fluid according to embodiments disclosed herein may be found in naturally occurring fluids, such naturally occurring fluids are not treatment fluids according to the present disclosure. For example, methylglyoxal is a known component of honey and other naturally occurring fluids (fluids produced without human intervention). However, honey and other naturally occurring fluids in their pure forms or in one or more refined forms are still naturally occurring fluids and therefore are not considered to be treatment fluids in the art, or according to embodiments disclosed herein.

For purposes herein, a “biopolymer” refers to polymers and derivatives of polymers produced by living organisms. Biopolymers comprise a plurality of monomeric units that are covalently bonded to form larger structures. In embodiments, biopolymer refers to polysaccharides in general, and linear bonded polymeric carbohydrate structures in particular. For purposes herein, a polysaccharide comprises a chain of 10 or more monosaccharide units bound together by glycosidic bonds, and may include both polysaccharides and oligosaccharides. Unless otherwise indicated, a biopolymer may include homopolysaccharides and/or heteropolysaccharides.

For purposes herein, the terms bacterial degradation and biological degradation are used interchangeably to refer to one or more properties of a polymer being altered by action of living or biological agents, including various bacteria and bacteria-like entities.

For purposes herein, aging of a fluid (e.g., a solution or mixture) in a non-sterile environment for purposes of determining the inhibition of biological degradation of the fluid may include the steps of preparing and characterizing a fluid in a non-sterile environment followed by allowing the fluid to age in the non-sterile environment (or non-sterile container) which is, or which has been in fluid communication with an external environment such that the fluid has been exposed to the ambient environment which inherently contains bacteria or other biological agents known to degrade such fluids at room temperature (i.e., 25° C.), followed by characterizing the aged fluid in essentially the same way under the same conditions using the same method utilized to characterize the fluid initially. For purposes herein, when viscosity is utilized to characterize the fluid, a shear rate of 1 s⁻¹ is assumed unless otherwise specified. Accordingly, in an embodiment, a polymer is susceptible to biological degradation if an aqueous solution or mixture comprising at least 0.1 wt % of the polymer has a second viscosity determined after about 3 days aging at 25° C. in a non-sterile environment, which is less than about 75% of an initial viscosity of the solution or mixture determined at the time at which the solution or mixture was produced at 25° C. at a shear rate of 1 s⁻¹, wherein the initial viscosity and the second viscosity are each determined at the same temperature, at a shear rate of 1 s⁻¹ under the same conditions using the same method.

In other words, aging a fluid in a non-sterile environment to evaluate the stability of the fluid against biological degradation may include the steps of preparing the fluid in a typical laboratory or industrial setting, determining the viscosity of the fluid, followed by aging the fluid at room temperature in a non-sterile container (which may be at least partially covered to prevent evaporation, but which has been or is exposed to the ambient atmosphere) in a typical laboratory or industrial setting, followed by repeating the viscosity measurement after aging using the same method and conditions employed initially.

“Carrier,” “fluid phase” or “liquid phase” refer to the fluid or liquid that is present as a continuous phase in the fluid. Reference to an “aqueous phase” refers to a carrier phase comprised predominantly of water, which may be a continuous or dispersed phase. As used herein the terms “liquid” or “liquid phase” encompasses both liquids per se and supercritical fluids, including any solutes dissolved therein.

The terms “particulate,” “particle” and “particle size” used herein refer to discrete quantities of solids, gels, semi-solids, liquids, gases and/or foams unless otherwise specified.

As used herein, a blend of particles and a fluid may be generally referred to as a slurry, an emulsion, or the like. For purposes herein “slurry” refers to a mixture of solid particles dispersed in a fluid carrier. An “emulsion” refers to a form of slurry in which either solid or liquid particles are of a size such that the particles do not exhibit a static internal structure, but are assumed to be statistically distributed. In some embodiments, an emulsion is a mixture of two or more liquids that are normally immiscible (nonmixable or unblendable). For purposes herein, an emulsion comprises at least two phases of matter, which may be a first liquid phase dispersed in a continuous (second) liquid phase, and/or a first liquid phase and one or more solid phases dispersed in a continuous (second) liquid phase. Emulsions may be oil-in-water, water-in-oil, or any combination thereof, e.g., a “water-in-oil-in-water” emulsion or an “oil-in-water-in-oil” emulsion. In embodiments, the slurry may be a brine.

Biopolymers such as guar are largely used as viscosity improvers and/or gelling agents (collectively referred to as viscosifiers) in oilfield and other applications. In many oilfield applications, an increased fluid viscosity is required to provide transport of materials (e.g., proppant, cuttings and the like) during well treatment operations. Moreover, guar and its derivatives such as hydroxypropyl guar (HPG), carboxymethyl hydroxypropyl guar (CMHPG), and the like, have the ability to be cross-linked, which further increases the viscosity or the gel stability of these polymers thus increasing the carrying capacity of proppants and other particulates. However, once hydrated, these and other biopolymers and/or synthetic polymers are subject to biological attack and degradation such that short term storage of hydrated biopolymers of less than a week, and/or long term storage of months or more may become problematic. Biological degradation of the biopolymers may adversely affect physiochemical properties of the biopolymers and thus, biological degradation may adversely affect the performance of the fluids. In particular, biological degradation may adversely affect the viscosity and other rheological properties of treatment fluids comprising these polymers. Biological degradation of the biopolymers may be a function of the environment, of equipment cleanness, location, and/or the like, which may require special handling of the materials, or which may be beyond the control of the end-user.

To prevent the biological degradation of biopolymers, bactericides, also referred to as biocides, are added to the fluid. Biocides, however, may interfere with or inhibit properties of the biopolymers. In addition, biocides may have toxicity concerns which require attention, and which may result in their use being heavily regulated.

In embodiments, the ability to inhibit biological degradation of a well treatment fluid may be improved by including a 2-oxo-aldehyde having 3 or more carbon atoms in the well treatment fluid. In embodiments, a well treatment fluid comprises a 2-oxo-aldehyde having 3 or more carbon atoms. In embodiments, the well treatment fluid comprises a 2-oxo-aldehyde having from 3 to 10 carbon atoms. In embodiments, the 2-oxo-aldehyde present in the fluid comprises, consists essentially of, or consists of methylglyoxal. In embodiments, the well treatment fluid comprises at least about 10 mg/L or 10 ppmw (0.001 weight percent), or from about 10 mg/L or 10 ppmw (0.001 weight percent) to about 10 g/L or 10,000 ppmw (1 weight percent) of the 2-oxo-aldehyde, based on the total volume or weight of the well treatment fluid.

In embodiments, the well treatment fluid may further comprise a polymer comprising a biopolymer, a synthetic polymer or a combination thereof. In embodiments, the polymer is subject to bacterial or biological degradation upon aging in hydrated form. In embodiments, the polymer is selected from the group consisting of guar, hydroxypropyl guar, carboxymethylhydroxypropyl guar, carboxymethyl guar, hydroxyethylcellulose, hydroxypropylcellulose, carboxymethylhydroxyethylcellulose, carboxymethycellulose, xanthan, diutan, scleroglucan, polyethylene glycol, polypropylene glycol, polyester, polyester-ether, polylactic acid, polyglycolic acid, polysulfonates, polycarboxylates, derivatives thereof and combinations thereof.

In embodiments, the well treatment fluid according to the instant disclosure may have a second viscosity or aged viscosity determined after about 3 days aging at 25° C. in a non-sterile environment, which is greater than or equal to about 75% of an initial viscosity of the well treatment fluid, wherein each viscosity is determined at a shear rate of 1 s⁻¹, under the same conditions using the same method. In embodiments, the biopolymer present in the well treatment fluid according to the instant disclosure may be at least partially crosslinked.

In embodiments, a method comprises combining a polymer comprising a biopolymer, a synthetic polymer or a combination thereof with a 2-oxo-aldehyde having 3 or more carbon atoms in a carrier fluid to form a well treatment fluid. In embodiments, the method comprises adding from about 10 mg/L or 10 ppmw (0.001 weight percent) to about 10 g/L or 10,000 ppmw (1 weight percent) of the 2-oxo-aldehyde having 3 or more carbon atoms to the carrier fluid, based on the total volume or weight of the well treatment fluid. In embodiments, the method may further comprise circulating a well treatment fluid according to the instant disclosure into a wellbore penetrating a formation. In embodiments, a method according to the instant disclosure may further comprise contacting the well treatment fluid with a breaker at a temperature and for a period of time sufficient to reduce a viscosity of the well treatment fluid. In embodiments, the polymer is at least partially crosslinked.

In embodiments, the well treatment fluid produced by a method according to the instant disclosure has a second viscosity determined after about 3 days aging at 25° C. in a non-sterile environment which is greater than or equal to about 75% of an initial viscosity of the well treatment fluid, wherein each viscosity is determined under the same conditions using the same method.

In embodiments, a method of inhibiting bacterial degradation of a well treatment fluid susceptible to bacterial degradation comprises adding a biocidally effective amount of a 2-oxo-aldehyde having 3 or more carbon atoms to the treatment fluid.

In embodiments, suitable examples of 2-oxo-aldehydes include a 2-substituted glyoxal having the structure:

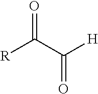

wherein R is a functional group comprising at least one carbon atom, or where R is a substituted or unsubstituted alkyl radical comprising from 1 to 8 carbon atoms. In embodiments, R is methyl, ethyl or propyl. In embodiments, R is methyl, which is also referred to in the art as methylglyoxal (MGO), pyruvaldehyde, pyruvic aldehyde, 2-oxopropanal or the like.

In embodiments, the 2-oxo-aldehyde is present in the well treatment fluid at a biocidally effective concentration, such as at least about 10 mg/L or 10 ppmw (0.001 weight percent), or at least about 20 mg/L or 20 ppmw (0.002 weight percent), or at least about 40 mg/L or 40 ppmw (0.004 weight percent), or at least about 80 mg/L or 80 ppmw (0.008 weight percent), or at least about 100 mg/L or 100 ppmw (0.01 weight percent), or at least about 200 mg/L or 200 ppmw (0.02 weight percent), based on the total volume or weight of the treatment fluid; and/or the 2-oxo-aldehyde is present in the well treatment fluid at a concentration of less than about 5 g/L or 5000 ppmw (0.5 weight percent), or less than about 1 g/L or 1000 ppmw (0.1 weight percent), or less than about 500 mg/L or 500 ppmw (0.05 weight percent), or less than about 250 mg/L or 250 ppmw (0.025 weight percent), or less than about 200 mg/L or 200 ppmw (0.02 weight percent), or less than about 100 mg/L or 100 ppmw (0.01 weight percent), or less than about 50 mg/L or 50 ppmw (0.005 weight percent), based on the total volume or weight of the treatment fluid; for example, 20-200 ppmw, 40-200 ppmw, etc.

In embodiments, the well treatment fluid according to any one or more embodiments comprises a mass ratio of the 2-oxo-aldehyde having 3 or more carbon atoms to the biopolymer, synthetic polymer, or a combination thereof, of from about 1:1000 to 1:2, or from about 1:200 to about 1:4, or from about 1:100 to about 1:5, or from about 1:50 to about 1:6.

In embodiments, the 2-oxo-aldehyde having 3 or more carbon atoms is combined with a biopolymer, a synthetic polymer, or both, which are subsequently combined with a carrier fluid to produce a treatment fluid. In an embodiment, the 2-oxo-aldehyde having 3 or more carbon atoms is combined with a biopolymer, a synthetic polymer or both in an amount of a carrier fluid to produce a masterbatch fluid, which is subsequently combined with an additional amount of one or more carrier fluids to produce a treatment fluid. In embodiments, the masterbatch fluid may contain the 2-oxo-aldehyde having 3 or more carbon atoms in an amount of at least about 100 mg/L or 100 ppmw (0.01 weight percent), or at least about 200 mg/L or 200 ppmw (0.02 weight percent), or at least about 400 mg/L or 400 ppmw (0.04 weight percent), or at least about 800 mg/L or 800 ppmw (0.08 weight percent), or at least about 1 g/L or 1000 ppmw (0.1 weight percent), or at least about 2 g/L or 2000 ppmw (0.2 weight percent), based on the total volume or weight of the masterbatch; and/or the 2-oxo-aldehyde is present in the masterbatch at a concentration of less than about 50 g/L or 50,000 ppmw (5 weight percent), or less than about 10 g/L or 10,000 ppmw (1 weight percent), or less than about 5 g/L or 5000 ppmw (0.5 weight percent), or less than about 2.5 g/L or 2500 ppmw (0.25 weight percent), or less than about 2 g/L or 2000 ppmw (0.2 weight percent), or less than about 1 g/L or 1000 ppmw (0.1 weight percent), or less than about 500 mg/L or 500 ppmw (0.05 weight percent), based on the total volume or weight of the masterbatch.

In embodiments, the well treatment fluid comprises a biopolymer, a synthetic polymer, and/or the like. For purposes herein, a polymer is susceptible to biological degradation if an aqueous solution or mixture comprising at least 0.1 wt % of the polymer has a second viscosity determined after about 3 days aging at 25° C. in a non-sterile environment, which is less than about 75% of an initial viscosity of the solution or mixture determined at the time at which the solution or mixture was produced, wherein the initial viscosity and the second viscosity are each determined under the same conditions of temperature, shear rate, concentration, and the like, using the same method. In embodiments, the polymer is selected from biopolymers including guar, hydroxypropyl guar, carboxymethylhydroxypropyl guar, carboxymethyl guar, derivatives thereof and combinations thereof, and the like; and/or cellulosic polymers including hydroxyethylcellulose, hydroxypropylcellulose, carboxymethylhydroxyethylcellulose, carboxymethycellulose, xanthan, diutan, scleroglucan, pectin, derivatives thereof, combinations thereof, and the like.

In embodiments, the polymer is a synthetic polymer, or a water-soluble synthetic polymer, which is otherwise effective as a viscosifying agent. Suitable water soluble synthetic polymers include acrylic acid-acrylamide copolymers, acrylic acid-methacrylamide copolymers, polyacrylamides, polymethacrylamides, partially hydrolyzed polyacrylamides, partially hydrolyzed polymethacrylamides, polyvinyl alcohol, polyalkyleneoxides including polyethylene glycol, polypropylene glycol, derivatives thereof, and combinations thereof, polyesters including both aliphatic and aromatic substituted polyesters, polyester-ethers, polymers and copolymers comprising polylactic acid and derivatives thereof, polyglycolic acid and derivatives thereof; polysulfonates, polycarboxylates, polyvinyl acetate polymers, derivatives thereof, and combinations thereof.

In embodiments, the biopolymer, and/or the synthetic polymer may be combined with the carrier fluid and then a biocidally effective amount of the 2-oxo-aldehyde may be added to the fluid. In other embodiments, at least one of the biopolymer and/or the synthetic polymer may be provided in combination with a biocidally effective amount of the 2-oxo-aldehyde and the mixture may then be combined with the carrier fluid to form the treatment fluid. In other embodiments, the biopolymer and/or the synthetic polymer combined with the carrier fluid and a biocidally effective amount of the 2-oxo-aldehyde may be supplied as a master-batch or at a concentration above that required to produce a treatment fluid, and the master batch may be subsequently diluted to produce the treatment fluid.

Accordingly, in embodiments at least one of the biopolymer, the synthetic polymer or a combination thereof is first combined with the 2-oxo-aldehyde having 3 or more carbon atoms to form an intermediate mixture, and the intermediate mixture is then combined with the carrier fluid to form the well treatment fluid. In other embodiments, at least one of the biopolymer, the synthetic polymer or a combination thereof is first combined with the carrier fluid to form an intermediate mixture, and the intermediate mixture is then combined with the 2-oxo-aldehyde having 3 or more carbon atoms to form the well treatment fluid.

In embodiments, the well treatment fluid comprises a polymer comprising a biopolymer or a synthetic polymer which is at least partially crosslinked. In embodiments, the polymer may be cross linked prior to the polymer being combined with the 2-oxo-aldehyde; the polymer may be cross linked contemporaneously with the polymer being combined with the t-oxo-aldehyde, or the polymer may be cross linked in the presence of the 2-oxo-aldehyde (i.e., after addition of the 2-oxo-aldehyde to the treatment fluid).

In embodiments, the well treatment fluid comprising a cross linked polymer comprises a second viscosity determined after about 3 days aging in a non-sterile environment at 25° C., which is greater than or equal to about 75% of an initial viscosity of the well treatment fluid, wherein each viscosity is determined under the same conditions using the same method. Crosslinking agents include any substance which increases the effective molecular weight of the polymer. In embodiments, the crosslinking agents employed may comprise boron, titanium, zirconium, aluminum, divalent organic radicals and/or the like.

In embodiments, the treatment fluid may additionally or alternatively include, without limitation, friction reducers, clay stabilizers, other biocides, crosslinkers, breakers, corrosion inhibitors, solvents, diluents, weighting agents, surfactants, particulates, proppant flowback control additives, acids, fluid loss control additives, gas, corrosion inhibitors, scale inhibitors, catalysts, clay control agents, a viscoelastic surfactants, and/or the like. The treatment fluid may further include a product formed from degradation, hydrolysis, hydration, chemical reaction or other process that occur during preparation or operation.

In embodiments, the viscoelastic surfactant (VES) may be selected from the group consisting of cationic, anionic, zwitterionic, amphoteric, nonionic and combinations thereof. Some non-limiting examples are those cited in U.S. Pat. No. 6,435,277 and U.S. Pat. No. 6,703,352, each of which is incorporated herein by reference. The viscoelastic surfactants, when used alone or in combination, are capable of forming micelles that form a structure in an aqueous environment that contribute to the increased viscosity of the fluid (also referred to as “viscosifying micelles”). These fluids are normally prepared by mixing in appropriate amounts of VES suitable to achieve the desired viscosity. The viscosity of VES fluids may be attributed to the three dimensional structure formed by the components in the fluids. When the concentration of surfactants in a viscoelastic fluid significantly exceeds a critical concentration, and in most cases in the presence of an electrolyte, surfactant molecules aggregate into species such as micelles, which can interact to form a network exhibiting viscous and elastic behavior.

In general, particularly suitable zwitterionic surfactants have the formula:

RCONH—(CH₂)ₐ(CH₂CH₂O)ₘ(CH₂)_{b}—N⁺—(CH₃)₂—(CH₂)_{a′}(CH₂CH₂O)_{m′}(CH₂)_{b′}COO⁻

in which R is an alkyl group that contains from about 11 to about 23 carbon atoms which may be branched or straight chained and which may be saturated or unsaturated; a, b, a′, and b′ are each from 0 to 10 and m and m′ are each from 0 to 13; a and b are each 1 or 2 if m is not 0 and (a+b) is from 2 to 10 if m is 0; a′ and b′ are each 1 or 2 when m′ is not 0 and (a′+b′) is from 1 to 5 if m is 0; (m+m′) is from 0 to 14; and CH₂CH₂O may also be OCH₂CH₂. In some embodiments, a zwitterionic surfactant of the family of betaine is used.

Exemplary cationic viscoelastic surfactants include the amine salts and quaternary amine salts disclosed in U.S. Pat. Nos. 5,979,557, and 6,435,277 which are hereby incorporated by reference. Examples of suitable cationic viscoelastic surfactants include cationic surfactants having the structure:

R¹N⁺(R²)(R³)(R⁴)X—

in which R¹ has from about 14 to about 26 carbon atoms and may be branched or straight chained, aromatic, saturated or unsaturated, and may contain a carbonyl, an amide, a retroamide, an imide, a urea, or an amine; R², R³, and R⁴ are each independently hydrogen or a C₁ to about C₆ aliphatic group which may be the same or different, branched or straight chained, saturated or unsaturated and one or more than one of which may be substituted with a group that renders the R², R³, and R⁴ group more hydrophilic; the R², R³, and R⁴ groups may be incorporated into a heterocyclic 5- or 6-member ring structure which includes the nitrogen atom; the R², R³, and R⁴ groups may be the same or different; R¹, R², R³, and/or R⁴ may contain one or more ethylene oxide and/or propylene oxide units; and X⁻ is an anion. Mixtures of such compounds are also suitable. As a further example, R¹ is from about 18 to about 22 carbon atoms and may contain a carbonyl, an amide, or an amine, and R², R³, and R⁴ are the same as one another and contain from 1 to about 3 carbon atoms.

Amphoteric viscoelastic surfactants are also suitable. Exemplary amphoteric viscoelastic surfactant systems include those described in U.S. Pat. No. 6,703,352, for example amine oxides. Other exemplary viscoelastic surfactant systems include those described in U.S. Pat. Nos. 6,239,183; 6,506,710; 7,060,661; 7,303,018; and 7,510,009 for example amidoamine oxides. These references are hereby incorporated in their entirety. Mixtures of zwitterionic surfactants and amphoteric surfactants are suitable. An example is a mixture of about 13% isopropanol, about 5% 1-butanol, about 15% ethylene glycol monobutyl ether, about 4% sodium chloride, about 30% water, about 30% cocoamidopropyl betaine, and about 2% cocoamidopropylamine oxide.

The viscoelastic surfactant system may also be based upon any suitable anionic surfactant. In some embodiments, the anionic surfactant is an alkyl sarcosinate. The alkyl sarcosinate can generally have any number of carbon atoms. Alkyl sarcosinates can have about 12 to about 24 carbon atoms. The alkyl sarcosinate can have about 14 to about 18 carbon atoms. Specific examples of the number of carbon atoms include 12, 14, 16, 18, 20, 22, and 24 carbon atoms. The anionic surfactant is represented by the chemical formula:

R¹CON(R²)CH₂X

wherein R¹ is a hydrophobic chain having about 12 to about 24 carbon atoms, R² is hydrogen, methyl, ethyl, propyl, or butyl, and X is carboxyl or sulfonyl. The hydrophobic chain can be an alkyl group, an alkenyl group, an alkylarylalkyl group, or an alkoxyalkyl group. Specific examples of the hydrophobic chain include a tetradecyl group, a hexadecyl group, an octadecentyl group, an octadecyl group and a docosenoic group.

In embodiments, the treatment fluid may comprise at least about 0.1 weight percent of the polymer, or at least about 0.5 weight percent, or at least about 1 weight percent, based on the total weight of the treatment fluid.

In embodiments, the carrier fluid may include an acid. In embodiments, the carrier fluid may include hydrochloric acid, hydrofluoric acid, ammonium bifluoride, formic acid, acetic acid, lactic acid, glycolic acid, maleic acid, tartaric acid, sulfamic acid, malic acid, citric acid, methyl-sulfamic acid, chloro-acetic acid, an amino-poly-carboxylic acid, 3-hydroxypropionic acid, a poly-amino-poly-carboxylic acid, and/or a salt of any acid. In embodiments, the carrier fluid includes a poly-amino-poly-carboxylic acid, which is a trisodium hydroxyl-ethyl-ethylene-diamine triacetate, mono-ammonium salts of hydroxyl-ethyl-ethylene-diamine triacetate and/or mono-sodium salts of hydroxyl-ethyl-ethylene-diamine tetra-acetate.

In embodiments, the treatment fluid includes a particulate material. In embodiments, the particulate material is a blend comprising proppant. Proppant selection involves many compromises imposed by economical and practical considerations. Criteria for selecting the proppant type, size, size distribution in multimodal proppant selection, and concentration is based on the needed dimensionless conductivity, and can be selected by a skilled artisan. Such proppants can be natural or synthetic (including but not limited to glass beads, ceramic beads, sand, and bauxite), coated, or contain chemicals; more than one can be used sequentially or in mixtures of different sizes or different materials. The proppant may be resin coated (curable), or pre-cured resin coated. Proppants and gravels in the same or different wells or treatments can be the same material and/or the same size as one another and the term proppant is intended to include gravel in this disclosure.

In embodiments, the treatment fluid is a slurry comprising particulate materials with one or more defined particles size distributions. On example of realization is disclosed in U.S. Pat. No. 7,784,541, herewith incorporated by reference in its entirety. In embodiments, the selection of the size for the first amount of particulates is dependent upon the characteristics of the formation as understood in the art. In an embodiment, the slurry may comprise a high solid content, comprising a plurality of particles having or approximating an apollonian particle size distribution as known in the art. In embodiments the selection of the size for a first amount of particulates is dependent upon the desired fluid loss characteristics of the first amount of particulates as a fluid loss agent, the size of pores in a formation, and/or the commercially available sizes of particulates of the type comprising the first amount of particulates.

In embodiments, the selection of the size of a second amount of particulates is dependent upon maximizing or optimizing a packed volume fraction (PVF) of the mixture of the first amount of particulates and the second amount of particulates. The packed volume fraction or packing volume fraction (PVF) is the fraction of solid content volume to the total volume content. A second average particle size of between about seven to ten times smaller than the first amount of particulates contributes to maximizing the PVF of the mixture, but a size between about three to twenty times smaller, and in certain embodiments between about three to fifteen times smaller, and in certain embodiments between about three to ten times smaller will provide a sufficient PVF for most slurry. Further, the selection of the size of the second amount of particulates is dependent upon the composition and commercial availability of particulates of the type comprising the second amount of particulates. In certain embodiments, the particulates combine to have a PVF above 0.70, 074 or 0.75 or above 0.80. In certain further embodiments the particulates may have a much higher PVF approaching 0.95. The optimization of the particles sizes distribution (Apollonian distribution), and dispersion of particles with high surface area lead to make fluids with high solid content (solid volume fraction from 50 to 70%), with a fluid density of greater than or equal to about 16 pounds per gallon of carrier fluid.

In embodiments, the treatment fluid may further include a third amount of particulates having a third average particle size that is smaller than the second average particle size. In certain further embodiments, the slurry may have a fourth, a fifth or a sixth amount of particles. Also in some embodiments, the same chemistry can be used for the third, fourth, fifth or sixth average particle size. Also in some embodiments, different chemistry can be used for the same third average particle size: e.g. in the third average particle size, half of the amount is a certain type of proppant and the other half is another type of proppant. For the purposes of enhancing the PVF of the slurry, more than three or four particles sizes will not typically be required. However, additional particles may be added for other reasons, such as the chemical composition of the additional particles, the ease of manufacturing certain materials into the same particles versus into separate particles, the commercial availability of particles having certain properties, and other reasons understood in the art.

In embodiments, the treatment fluids may be used for carrying out a variety of subterranean treatments, including, but not limited to, drilling operations, fracturing treatments, and completion operations (e.g., gravel packing). In some embodiments, the treatment fluids may be used in treating a portion of a subterranean formation. In embodiments, a treatment fluid may be introduced into a well bore that penetrates the subterranean formation. Optionally, the treatment fluid further may comprise particulates and other additives suitable for treating the subterranean formation. For example, the treatment fluid may be allowed to contact the subterranean formation for a period of time. In some embodiments, the treatment fluid may be allowed to contact hydrocarbons, formations fluids, and/or subsequently injected treatment fluids. After a chosen time, the treatment fluid may be recovered through the well bore. In certain embodiments, the treatment fluids may be used in gravel packing, fracturing treatments, fracturing and gravel packing in one operation (called, for example frac and pack, frac-n-pack, frac-pack, StimPac® treatments, or other names), and the like.

### EMBODIMENTS

As is evident from the disclosure herein, a variety of embodiments are contemplated:
1. A well treatment fluid comprising a 2-oxo-aldehyde having 3 or more carbon atoms.
2. The well treatment of embodiment 1, wherein the 2-oxo-aldehyde has from 3 to 10 carbon atoms.
3. The well treatment fluid of embodiments 1 or 2, wherein the 2-oxo-aldehyde is methylglyoxal.
4. The well treatment fluid of any one of embodiments 1 to 3, comprising a biocidally effective concentration of the 2-oxo-aldehyde, or the 2-oxo-aldehyde is present in an amount at least about 10 mg/L or 10 ppmw (0.001 weight percent), or at least about 20 mg/L or 20 ppmw (0.002 weight percent), or at least about 40 mg/L or 40 ppmw (0.004 weight percent), or at least about 80 mg/L or 80 ppmw (0.008 weight percent), or at least about 100 mg/L or 100 ppmw (0.01 weight percent), or at least about 200 mg/L or 200 ppmw (0.02 weight percent), based on the total volume or weight of the treatment fluid; or the 2-oxo-aldehyde is present in an amount of less than about 5 g/L or 5000 ppmw (0.5 weight percent), or less than about 1 g/L or 1000 ppmw (0.1 weight percent), or less than about 500 mg/L or 500 ppmw (0.05 weight percent), or less than about 250 mg/L or 250 ppmw (0.025 weight percent), or less than about 200 mg/L or 200 ppmw (0.02 weight percent), or less than about 100 mg/L or 100 ppmw (0.01 weight percent), or less than about 50 mg/L or 50 ppmw (0.005 weight percent), based on the total volume or weight of the treatment fluid; or the 2-oxo-aldehyde is present in an amount of 20-200 ppmw or 40-200 ppmw.
5. The well treatment fluid of any one of embodiments 1 to 4, further comprising a biopolymer, a synthetic polymer; or a combination thereof
6. The well treatment fluid of any one of embodiments 1 to 5, comprising a polymer selected from the group consisting of guar, hydroxypropyl guar, carboxymethylhydroxypropyl guar, carboxymethyl guar, hydroxyethylcellulose, hydroxypropylcellulose, carboxymethylhydroxyethylcellulose, carboxymethycellulose, xanthan, diutan, scleroglucan, polyethylene glycol, polypropylene glycol, polyester, polyester-ether, polylactic acid, polyglycolic acid, polysulfonate, polycarboxylate, derivatives thereof, and combinations thereof
7. The well treatment fluid of any one of embodiments 1 to 6, having a second viscosity determined after about 3 days aging at 25° C. in a non-sterile environment which is greater than or equal to about 75% of an initial viscosity of the well treatment fluid, wherein each viscosity is determined under the same conditions using the same method.
8. The well treatment fluid of any one of embodiments 1 to 7, comprising a biopolymer, a synthetic polymer, or a combination thereof, which is at least partially crosslinked.
9. The well treatment fluid of embodiment 8, having a second viscosity determined after about 3 days aging at 25° C. in a non-sterile environment which is greater than or equal to about 75% of an initial viscosity of the well treatment fluid, wherein each viscosity is determined under the same conditions using the same method.
10. The well treatment fluid of any one of embodiments 1 to 8 wherein a mass ratio of the t-oxo-aldehyde having 3 or more carbon atoms to the biopolymer, synthetic polymer, or a combination thereof, is from about 1:1000 to 1:2.
11. A method comprising: combining a biopolymer, a synthetic polymer, or a combination thereof with a 2-oxo-aldehyde having 3 or more carbon atoms in a carrier fluid to form a well treatment fluid.
12. The method of embodiment 11, wherein the well treatment fluid comprises from a biocidally effective concentration of the 2-oxo-aldehyde, or the 2-oxo-aldehyde is present in an amount at least about 10 mg/L or 10 ppmw (0.001 weight percent), or at least about 20 mg/L or 20 ppmw (0.002 weight percent), or at least about 40 mg/L or 40 ppmw (0.004 weight percent), or at least about 80 mg/L or 80 ppmw (0.008 weight percent), or at least about 100 mg/L or 100 ppmw (0.01 weight percent), or at least about 200 mg/L or 200 ppmw (0.02 weight percent), based on the total volume or weight of the treatment fluid; or the 2-oxo-aldehyde is present in an amount of less than about 5 g/L or 5000 ppmw (0.5 weight percent), or less than about 1 g/L or 1000 ppmw (0.1 weight percent), or less than about 500 mg/L or 500 ppmw (0.05 weight percent), or less than about 250 mg/L or 250 ppmw (0.025 weight percent), or less than about 200 mg/L or 200 ppmw (0.02 weight percent), or less than about 100 mg/L or 100 ppmw (0.01 weight percent), or less than about 50 mg/L or 50 ppmw (0.005 weight percent), based on the total volume or weight of the treatment fluid; or the 2-oxo-aldehyde is present in an amount of 20-200 ppmw or 40-200 ppmw.
13. The method of embodiments 11 or 12, further comprising circulating the well treatment fluid into a wellbore.
14. The method of any one of embodiments 11 to 13, wherein the 2-oxo-aldehyde is methylglyoxal.
15. The method of any one of embodiments 11 to 14, wherein the polymer is selected from the group consisting of guar, hydroxypropyl guar, carboxymethylhydroxypropyl guar, carboxymethyl guar, hydroxyethylcellulose, hydroxypropylcellulose, carboxymethylhydroxyethylcellulose, carboxymethycellulose, xanthan, diutan, scleroglucan, polyethylene glycol, polypropylene glycol, polyester, polyester-ether, polylactic acid, polyglycolic acid, polysulfonate, polycarboxylate, derivatives thereof, and combinations thereof
16. The method of any one of embodiments 11 to 15, wherein the well treatment fluid has a second viscosity determined after about 3 days aging at 25° C. in a non-sterile environment which is greater than or equal to about 75% of an initial viscosity of the well treatment fluid, wherein each viscosity is determined under the same conditions using the same method.
17. The method of any one of embodiments 11 to 16, further comprising contacting the well treatment fluid with a breaker at a temperature and for a period of time sufficient to reduce a viscosity of the well treatment fluid.
18. The method of any one of embodiments 10 to 16, wherein the well treatment fluid comprises a biopolymer, a synthetic polymer, or a combination thereof, which is at least partially crosslinked.
19. The method of embodiment 18, wherein the well treatment fluid has a second viscosity determined after about 3 days aging at 25° C. in a non-sterile environment which is greater than or equal to about 75% of an initial viscosity of the well treatment fluid, wherein each viscosity is determined under the same conditions using the same method.
20. The method of any one of embodiments 11 to 19, further comprising contacting the well treatment fluid with a breaker at a temperature and for a period of time sufficient to reduce a viscosity of the well treatment fluid.
21. The method of any one of embodiments 101 to 19, wherein at least one of the biopolymer, the synthetic polymer, or a combination thereof is first combined with the t-oxo-aldehyde having 3 or more carbon atoms to form an intermediate mixture, and the intermediate mixture is then combined with the carrier fluid to form the well treatment fluid.
22. The method of any one of embodiments 11 to 19, wherein at least one of the biopolymer, the synthetic polymer, or a combination thereof is first combined with the carrier fluid to form an intermediate mixture, and the intermediate mixture is then combined with the t-oxo-aldehyde having 3 or more carbon atoms to form the well treatment fluid.
23. A method of inhibiting biological degradation of a well treatment fluid susceptible to biological degradation comprising adding a biocidally effective amount of a 2-oxo-aldehyde having 3 or more carbon atoms to the treatment fluid.
24. A method comprising:
   combining a 2-oxo-aldehyde having 3 or more carbon atoms with a biopolymer, a synthetic polymer, or a combination thereof in a first amount of one or more carrier fluids to produce a masterbatch fluid, and
   combining the masterbatch fluid with an amount of one or more carrier fluids according any one of embodiments 11 to 22 to produce a treatment fluid according to any one of embodiments 1 to 10.
25. A method comprising:
   combining a 2-oxo-aldehyde having 3 or more carbon atoms with a biopolymer, a synthetic polymer, or a combination thereof in one or more carrier fluids according any one of embodiments 11 to 22, to produce a treatment fluid according to any one of embodiments 1 to 10.

### Examples

The biocidal activity of a 2-oxo-aldehyde having 3 or more carbon atoms such as methylglyoxal on a guar system was evaluated. Four samples were prepared as shown in Table 1. Each of the samples had similar concentration of guar and different concentrations of MGO (from 40 to 198 mg/L (40 to 198 ppmw)). Samples were maintained at room temperature and their viscosities were measured directly after their preparation (in a non-sterile environment) and then again determined after the different periods of time aging at 25° C. in a non-sterile environment as indicated.

TABLE 1
Sample formulation with and without methylglyoxal

| | | Comparative | | | |
|---|---|---|---|---|---|
| Materials | Units | Sample A | Sample B | Sample C | Sample D |
| Water | Wt % | 99.5223 | 99.5124 | 99.5025 | 99.4728 |
| Guar | Wt % | 0.4777 | 0.4776 | 0.4776 | 0.4775 |
| Methylglyoxal | Wt % | 0 | 0.0099 | 0.0199 | 0.0497 |
| solution (40 | | | | | |
| wt % in water) | | | | | |
| Methylglyoxal | mg/L | 0 | 39.8 | 79.9 | 199.8 |

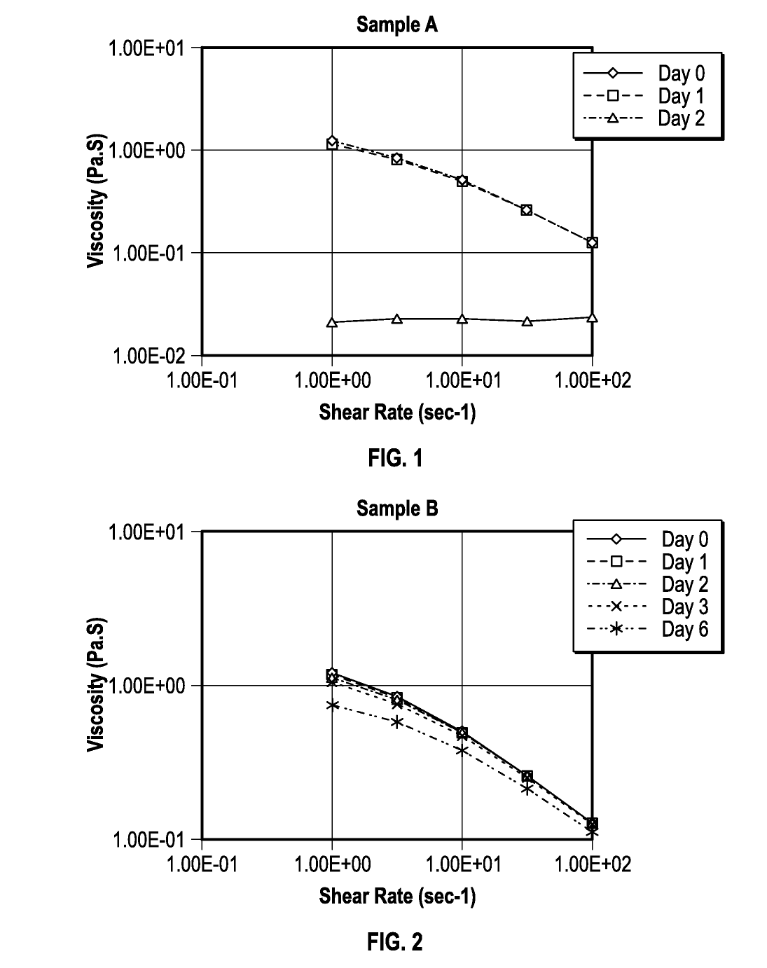

The viscosity of comparative sample A was determined initially and then again after two days of aging at 25° C. in a non-sterile environment (i.e., in a covered beaker on a lab bench.) The data are shown in Table 2, and shown graphically in FIG. 1.

TABLE 2
Comparative Sample A

| Shear | Initial | 2 day aged | Difference between |
|---|---|---|---|
| Rate | Viscosity | Viscosity | initial and aged |
| (sec⁻¹) | (Pa · s) | (Pa · s) | viscosity (%) |
| 1 | 1.145 | 0.021 | 98% |
| 3 | 0.813 | 0.023 | 97% |
| 10 | 0.495 | 0.023 | 95% |
| 31 | 0.26 | 0.021 | 92% |
| 100 | 0.127 | 0.023 | 82% |

FIG. 1 shows that the viscosity of comparative sample A (the absence of 2-oxo-aldehyde such as MGO) decreased drastically after 48 hours, which is the result of biological degradation of the polymer.

The viscosity of sample B was determined initially and then again after 1, 2, 3, and 6 days of aging at 25° C. in a non-sterile environment, i.e., in a covered beaker on a lab bench. The initial data, the 3 day aging data, and the 6 day aging data are shown in Table 3. The entire data set is shown graphically in FIG. 2.

TABLE 3
Sample B Aged Viscosity Data

| | | | Difference | | Difference |
|---|---|---|---|---|---|
| | | | between | | between |
| Shear | Initial | 3 day aged | initial and 3 | 6 day aged | initial and 6 |
| Rate | Viscosity | Viscosity | day aged | Viscosity | day aged |
| (sec⁻¹) | (Pa · s) | (Pa · s) | viscosity (%) | (Pa · s) | viscosity (%) |
| 1 | 1.204 | 1.05 | 12.8 | 0.736 | 38.87% |
| 3 | 0.842 | 0.758 | 9.9 | 0.572 | 32.07% |
| 10 | 0.502 | 0.466 | 7.17 | 0.373 | 25.70% |
| 31 | 0.259 | 0.248 | 4.25 | 0.212 | 18.15% |
| 100 | 0.124 | 0.122 | 1.61 | 0.110 | 11.29% |

FIG. 2 shows that the viscosity of sample B (containing 0.0099 weight percent of a 0.01 weight percent solution of MGO) remains the same during the first three days. After six days, this viscosity decreases only slightly. Accordingly, the presence of relatively dilute concentrations of a 2-oxo-aldehyde such as MGO is effective in reducing biological degradation (i.e., maintaining the physiochemical stability of the guar fluid) over a period of at least 6 days.

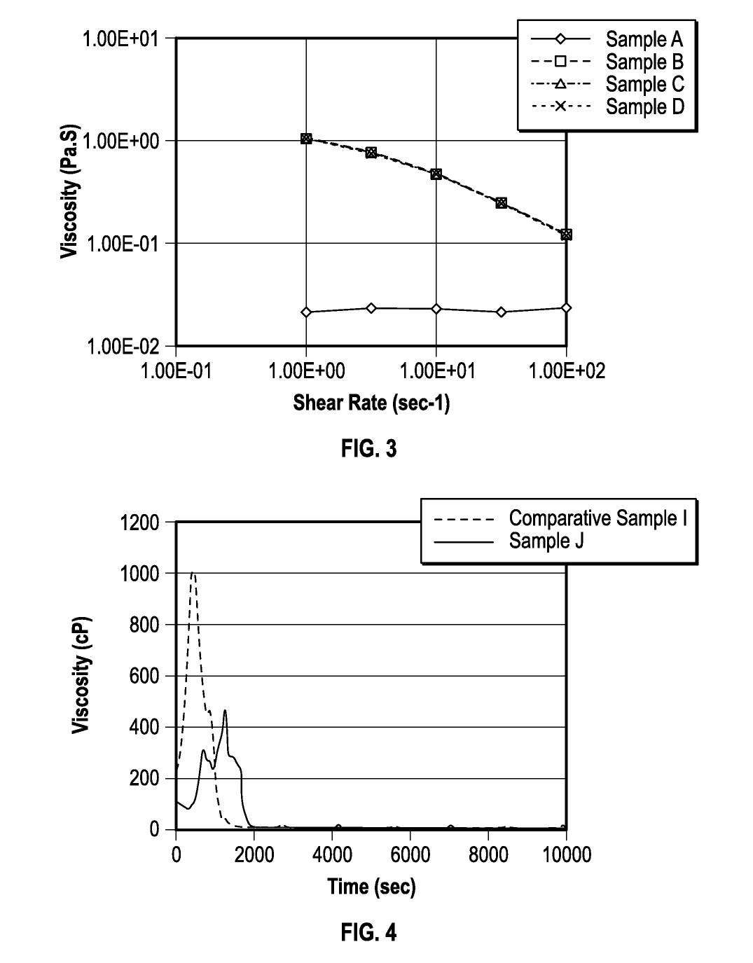

The viscosities of comparative sample A and samples B, C and D were determined initially and after 3 days of aging. The data are shown graphically in FIG. 3. As FIG. 3 shows, that higher concentrations of MGO (samples C and D) are slightly more effective in reducing biological degradation compared to Comparative Sample A and Sample B.

The effects of the biocide on cross linking were evaluated. It is known that chemical contamination may have a detrimental impact on the cross linking of guar and other polymers. The impact of 2-oxo-aldehyde such as MGO on guar crosslinking was evaluated using the vortex closure time of a solution of guar. Vortex closure time is determined by charging a portion of the gel in a blender and measuring the time required for the vortex produced upon initiation of mixing the solution in the blender to close. A non-crosslinked material does not have a vortex closure time. In other words, a non-crosslinked or minimally crosslinked mixture with have an infinite vortex closure time. The higher the level of crosslinking, the shorter the vortex closure time once mixing is initiated.

A comparative sample E and a sample F were prepared by mixing 0.5 g of guar in 99.5 g water and mixing in the blender. Sample F further included 0.4 g MGO solution (0.16 g of MGO). No vortex closure occurred while mixing the uncrosslinked samples. Next, an amount of a Boron based crosslinking agent was added to each of the mixing samples and the initial vortex closure time was measured as shown in Table 4. The vortex closure time was then measured after 4 days of aging at room temperature (25° C.) in a non-sterile environment, and then again after 6 days of aging at 25° C. The data are shown in Table 4. As the data show, the presence of 2-oxo-aldehyde such as MGO at 160 mg/L (0.4 gpt) does not have any impact on the vortex closure time even after several days due to the effectiveness of 2-oxo-aldehyde such as MGO in preventing degradation. The data also confirm that biological degradation has a pronounced effect on cross-linking. Accordingly, MGO does not prevent or interfere with the crosslinking of the polymer.

TABLE 4
vortex closure time as function of time in presence of MGO

| Vortex closure | Comparative Sample E | Sample F |
|---|---|---|
| time at | (w/o MGO) | w/160 mg/L MGO |
| Day 0 | 3.56 sec | Not measured |
| Day 1 | Not measured | 3.1 sec |
| Day 4 | Not measurable (no | 3.5 sec |
| | vortex closure) | |
| Day 6 | Not measurable (no | 4.0 sec |
| | vortex closure) | |

Two samples were evaluated to determine the impact of the MGO on the breaking schedule of a guar solution. A comparative sample I and sample J were prepared as shown in Table 5. The viscosity of each sample was measured at a shear rate of 100 sec⁻¹ while aging at 66° C. (150° F.) in the presence of an oxidizer (a breaker) to determine the effect 2-oxo-aldehyde such as MGO has on gel stability. The data is shown graphically in FIG. 4. As the figure shows, 2-oxo-aldehyde such as MGO does not have a significant impact on the breaking schedule of a guar gel.

TABLE 5
Sample formulation for breaking schedule test

| | | Comparative | |
|---|---|---|---|
| Materials | Units | Sample I | Sample J |
| Water | Wt % | 99.252 | 99.202 |
| Guar | Wt % | 0.476 | 0.476 |
| Methylglyoxal solution | Wt % | 0 | 0.050 |
| (40 wt % in water) | | | |
| Boron Crosslinker | Wt % | 0.249 | 0.248 |
| Oxidizer (Breaker) | Wt % | 0.0238 | 0.024 |

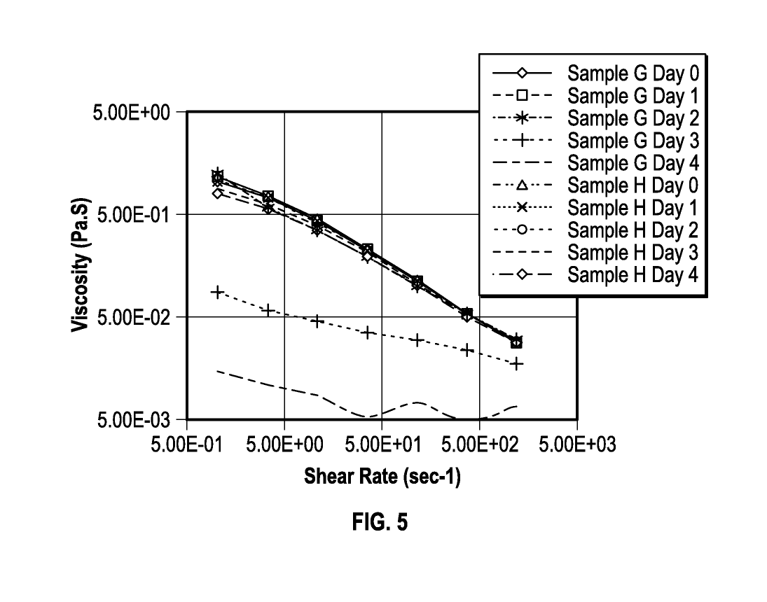

The efficacy of 2-oxo-aldehyde such as MGO as a biocide was investigated on highly concentrated guar fluids (˜200 ppt) produced as a water in water emulsion. Comparative sample G and sample H were prepared without and with MGO respectively. After dilution of the concentrated fluids (1 part of sample to 4 parts of water) their rheological properties were measured after 0, 1, 2, 3, and 4 days. The data are shown graphically in FIG. 5. As the data show, biological degradation induces a decrease or drop in the viscosity in comparison with the initial viscosity determined at day 0. After three days of aging at 25° C., comparative sample G (without MGO) presents a much lower viscosity than its initial value at day 0, i.e. the fluid in comparative sample G has been degraded. The viscosity of sample H after 4 days aging is similar to the initial viscosity of sample H determined at day 0. Accordingly, 2-oxo-aldehyde such as MGO has prevented biological degradation of the concentrated guar fluids.

TABLE 6
Formulation of highly concentrated fluids

| | | Comparative | |
|---|---|---|---|
| Materials | Unit | Sample G | Sample H |
| Water | Wt % | 95.329 | 94.967 |
| Guar | Wt % | 2.288 | 2.279 |
| PEG (8,000 g/mol) | Wt % | 2.383 | 2.374 |
| Methylglyoxal solution | Wt % | 0.0 | 0.380 |
| (40 wt % in water) | | | |

The foregoing disclosure and description is illustrative and explanatory thereof and it can be readily appreciated by those skilled in the art that various changes in the size, shape and materials, as well as in the details of the illustrated construction or combinations of the elements described herein can be made without departing from the spirit of the disclosure.

We claim:

1. A well treatment fluid comprising a 2-oxo-aldehyde having 3 or more carbon atoms.

2. The well treatment fluid of claim 1, wherein the 2-oxo-aldehyde has from 3 to 10 carbon atoms.

3. The well treatment fluid of claim 1, wherein the 2-oxo-aldehyde is methylglyoxal.

4. The well treatment fluid of claim 1, comprising from about 10 mg/L to about 5 g/L of the 2-oxo-aldehyde, based on the total volume of the well treatment fluid.

5. The well treatment fluid of claim 1, further comprising a biopolymer, a synthetic polymer; or a combination thereof.

6. The well treatment fluid of claim 5, wherein a mass ratio of the 2-oxo-aldehyde having 3 or more carbon atoms to the biopolymer, synthetic polymer, or a combination thereof, is from about 1:1000 to 1:2.

7. The well treatment fluid of claim 5 comprising a polymer selected from the group consisting of guar, hydroxypropyl guar, carboxymethylhydroxypropyl guar, carboxymethyl guar, hydroxyethylcellulose, hydroxypropylcellulose, carboxymethylhydroxyethylcellulose, carboxymethycellulose, xanthan, diutan, scleroglucan, polyethylene glycol, polypropylene glycol, polyester, polyester-ether, polylactic acid, polyglycolic acid, polysulfonate, polycarboxylate, derivatives thereof, and combinations thereof.

8. The well treatment fluid of claim 5, having a second viscosity determined after about 3 days aging at 25° C. in a non-sterile environment which is greater than or equal to about 75% of an initial viscosity of the well treatment fluid, wherein each viscosity is determined under the same conditions using the same method.

9. The well treatment fluid of claim 5, comprising a biopolymer, a synthetic polymer, or a combination thereof, which is at least partially crosslinked.

10. The well treatment fluid of claim 9, wherein a mass ratio of the 2-oxo-aldehyde having 3 or more carbon atoms to the biopolymer, synthetic polymer, or a combination thereof, is from about 1:1000 to 1:2.

11. The well treatment fluid of claim 8, having a second viscosity determined after about 3 days aging at 25° C. in a non-sterile environment which is greater than or equal to about 75% of an initial viscosity of the well treatment fluid, wherein each viscosity is determined under the same conditions using the same method.

12. A method comprising:
combining a biopolymer, a synthetic polymer, or a combination thereof with a 2-oxo-aldehyde having 3 or more carbon atoms in a carrier fluid to form a well treatment fluid.

13. The method of claim 12, wherein the well treatment fluid comprises from about 10 mg/L to about 5 g/L of the 2-oxo-aldehyde having 3 or more carbon atoms, based on the total volume of the well treatment fluid.

14. The method of claim 12, further comprising circulating the well treatment fluid into a wellbore penetrating a formation.

15. The method of claim 12, wherein the 2-oxo-aldehyde is methylglyoxal.

16. The method of claim 12, wherein the polymer is selected from the group consisting of guar, hydroxypropyl guar, carboxymethylhydroxypropyl guar, carboxymethyl guar, hydroxyethylcellulose, hydroxypropylcellulose, carboxymethylhydroxyethylcellulose, carboxymethycellulose, xanthan, diutan, scleroglucan, polyethylene glycol, polypropylene glycol, polyester, polyester-ether, polylactic acid, polyglycolic acid, polysulfonate, polycarboxylate, derivatives thereof, and combinations thereof.

17. The method of claim 12, wherein the well treatment fluid has a second viscosity determined after about 3 days aging at 25° C. in a non-sterile environment which is greater than or equal to about 75% of an initial viscosity of the well treatment fluid, wherein each viscosity is determined under the same conditions using the same method.

18. The method of claim 12, further comprising contacting the well treatment fluid with a breaker at a temperature and for a period of time sufficient to reduce a viscosity of the well treatment fluid.

19. The method of claim 12, wherein the well treatment fluid comprises a biopolymer, a synthetic polymer, or both which is at least partially crosslinked.

20. The method of claim 19, wherein the well treatment fluid has a second viscosity determined after about 3 days aging at 25° C. in a non-sterile environment which is greater than or equal to about 75% of an initial viscosity of the well treatment fluid, wherein each viscosity is determined under the same conditions using the same method.

21. The method of claim 19, further comprising contacting the well treatment fluid with a breaker at a temperature and for a period of time sufficient to reduce a viscosity of the well treatment fluid.

22. The method of claim 12, wherein at least one of the biopolymer, the synthetic polymer, or a combination thereof is first combined with the 2-oxo-aldehyde having 3 or more carbon atoms to form an intermediate mixture, and the intermediate mixture is then combined with the carrier fluid to form the well treatment fluid.

23. The method of claim 12, wherein at least one of the biopolymer, the synthetic polymer, or a combination thereof is first combined with the carrier fluid to form an intermediate mixture, and the intermediate mixture is then combined with the 2-oxo-aldehyde having 3 or more carbon atoms to form the well treatment fluid.

24. A method of inhibiting biological degradation of a well treatment fluid susceptible to biological degradation comprising adding a biocidally effective amount of a 2-oxo-aldehyde having 3 or more carbon atoms to a treatment fluid, or to a component which is subsequently added to a treatment fluid.

25. A method comprising:
combining a 2-oxo-aldehyde having 3 or more carbon atoms with a biopolymer, a synthetic polymer, or a combination thereof in a first amount of one or more carrier fluids to produce a masterbatch fluid, and
combining the masterbatch fluid with an amount of one or more carrier fluids to produce a treatment fluid.
